(19) United States
(12) Patent Application Publication
(10) Pub. No.: US 2021/0373662 A1
(43) Pub. Date: Dec. 2, 2021

(54) ENHANCEMENT OF EXTENDED REALITY (XR) INTERACTIONS

(71) Applicant: AT&T Intellectual Property I, L.P., Atlanta, GA (US)

(72) Inventors: James Pratt, Round Rock, TX (US); Nigel Bradley, McDonough, GA (US); Nikhil Marathe, Palatine, IL (US); Eric Zavesky, Austin, TX (US)

(21) Appl. No.: 16/886,547

(22) Filed: May 28, 2020

(51) Int. Cl. G06F 3/01

(52) U.S. Cl. CPC G06F 3/014; G06F 3/016

(57) ABSTRACT

In one example, a method includes obtaining a set of extended reality experience information associated with an extended reality experience where the set of extended reality experience information is indicative of an expected extended reality experience for an object type, obtaining a set of object property information of a first object of the object type, obtaining a set of haptic device capability information of a wearable haptic device used to interact with the first object, determining, based on the set of object property information and the set of haptic device capability information, an actual extended reality experience for the object type, and initiating, based on a determined delta between the expected extended reality experience for the object type and the actual extended reality experience for the object type, a message configured to cause a printing of a second object of the object type for the extended reality experience.

The present disclosure relates generally to extended reality (XR) and, more particularly, to various methods, computer-readable media, and apparatuses for supporting enhancement of XR experiences based on enhancement of XR interactions associated with XR experiences.

### BACKGROUND

XR is an umbrella term that is used to describe various types of immersive technology, including augmented reality (AR), virtual reality (VR), mixed reality (MR), and cinematic reality (CR), among others. Generally speaking, XR technologies allow virtual world (e.g., digital) objects to be brought into “real” (e.g., non-virtual) world environments and also allow real world objects to be brought into virtual environments (e.g., via overlays or other mechanisms). XR technologies may have applications in fields including entertainment, gaming, learning, training, medicine, architecture, real estate, engineering, travel, and others. As such, immersive experiences that rely on XR technologies are continuing to grow in popularity. As XR technology improves, there has been an increasing effort to improve various aspects of the user XR experience.

### SUMMARY

The present disclosure relates generally to extended reality (XR) and, more particularly, to various methods, computer-readable media, and apparatuses for supporting enhancement of XR experiences. In one example, XR experiences may be enhanced based on enhancement of XR interactions associated with the XR experiences.

In one example, the present disclosure relates to various methods, computer-readable media, and apparatuses for supporting enhancement of XR experiences based on replication of XR interactions. In one example, a method is performed by a processing system including at least one processor. The method includes obtaining a set of extended reality experience information associated with an extended reality experience, wherein the set of extended reality experience information is indicative of an expected extended reality experience for an object type. The method includes obtaining a set of object property information of a first object of the object type in the extended reality experience. The method includes obtaining a set of haptic device capability information of a wearable haptic device used to interact with the first object in the extended reality experience. The method includes determining, based on the set of object property information and the set of haptic device capability information, an actual extended reality experience for the object type. The method includes determining a delta between the expected extended reality experience for the object type and the actual extended reality experience for the object type. The method includes initiating, based on the delta between the expected extended reality experience for the object type and the actual extended reality experience for the object type, a message configured to cause a printing of a second object of the object type for the extended reality experience.

In one example, a computer-readable medium stores instructions which, when executed by a processing system, cause the processing system to perform operations. The operations include obtaining a set of extended reality experience information associated with an extended reality experience, wherein the set of extended reality experience information is indicative of an expected extended reality experience for an object type. The operations include obtaining a set of object property information of a first object of the object type in the extended reality experience. The operations include obtaining a set of haptic device capability information of a wearable haptic device used to interact with the first object in the extended reality experience. The operations include determining, based on the set of object property information and the set of haptic device capability information, an actual extended reality experience for the object type. The operations include determining a delta between the expected extended reality experience for the object type and the actual extended reality experience for the object type. The operations include initiating, based on the delta between the expected extended reality experience for the object type and the actual extended reality experience for the object type, a message configured to cause a printing of a second object of the object type for the extended reality experience.

In one example, an apparatus includes a processing system including at least one processor and a computer-readable medium storing instructions which, when executed by the processing system, cause the processing system to perform operations. The operations include obtaining a set of extended reality experience information associated with an extended reality experience, wherein the set of extended reality experience information is indicative of an expected extended reality experience for an object type. The operations include obtaining a set of object property information of a first object of the object type in the extended reality experience. The operations include obtaining a set of haptic device capability information of a wearable haptic device used to interact with the first object in the extended reality experience. The operations include determining, based on the set of object property information and the set of haptic device capability information, an actual extended reality experience for the object type. The operations include determining a delta between the expected extended reality experience for the object type and the actual extended reality experience for the object type. The operations include initiating, based on the delta between the expected extended reality experience for the object type and the actual extended reality experience for the object type, a message configured to cause a printing of a second object of the object type for the extended reality experience.

In one example, the present disclosure relates to various methods, computer-readable media, and apparatuses for supporting enhancement of XR experiences based on calibration of XR interactions. In one example, a method is performed by a processing system including at least one processor. The method includes sending, toward a device, a set of extended reality experience information associated with an extended reality experience, wherein the extended reality experience is based on an interaction between a haptic wearable device and an object. The method includes obtaining, from the haptic wearable device, a set of haptic feedback information collected by the haptic wearable device based on the interaction between the haptic wearable device and the object. The method includes obtaining, from the object, a set of object feedback information collected by the object based on the interaction between the haptic wearable device and the object. The method includes updating, based on at least one of the set of haptic feedback information and the set of object feedback information, at least a portion of the set of extended reality experience information associated with the extended reality experience to form thereby a new set of extended reality experience information associated with the extended reality experience. The method includes sending, toward the device, the new set of extended reality experience information associated with the extended reality experience.

In one example, a computer-readable medium stores instructions which, when executed by a processing system, cause the processing system to perform operations. The operations include sending, toward a device, a set of extended reality experience information associated with an extended reality experience, wherein the extended reality experience is based on an interaction between a haptic wearable device and an object. The operations include obtaining, from the haptic wearable device, a set of haptic feedback information collected by the haptic wearable device based on the interaction between the haptic wearable device and the object. The operations include obtaining, from the object, a set of object feedback information collected by the object based on the interaction between the haptic wearable device and the object. The operations include updating, based on at least one of the set of haptic feedback information and the set of object feedback information, at least a portion of the set of extended reality experience information associated with the extended reality experience to form thereby a new set of extended reality experience information associated with the extended reality experience. The operations include sending, toward the device, the new set of extended reality experience information associated with the extended reality experience.

In one example, an apparatus includes a processing system including at least one processor and a computer-readable medium storing instructions which, when executed by the processing system, cause the processing system to perform operations. The operations include sending, toward a device, a set of extended reality experience information associated with an extended reality experience, wherein the extended reality experience is based on an interaction between a haptic wearable device and an object. The operations include obtaining, from the haptic wearable device, a set of haptic feedback information collected by the haptic wearable device based on the interaction between the haptic wearable device and the object. The operations include obtaining, from the object, a set of object feedback information collected by the object based on the interaction between the haptic wearable device and the object. The operations include updating, based on at least one of the set of haptic feedback information and the set of object feedback information, at least a portion of the set of extended reality experience information associated with the extended reality experience to form thereby a new set of extended reality experience information associated with the extended reality experience. The operations include sending, toward the device, the new set of extended reality experience information associated with the extended reality experience.

### BRIEF DESCRIPTION OF THE DRAWINGS

The teachings of the present disclosure can be readily understood by considering the following detailed description in conjunction with the accompanying drawings, in which:

FIG. 1 illustrates an example system for supporting enhancement of extended reality (XR) interactions;

FIG. 2 illustrates a flowchart of an example method for supporting enhancement of XR interactions;

FIG. 3 illustrates a flowchart of an example method for supporting enhancement of XR interactions based on replication of XR interactions;

FIG. 4 illustrates a flowchart of an example method for supporting enhancement of XR interactions based on calibration of XR interactions; and

FIG. 5 illustrates a high level block diagram of a computing system specifically programmed to perform various steps, functions, blocks, and/or operations described herein.

To facilitate understanding, identical reference numerals have been used, where possible, to designate identical elements that are common to the figures.

### DETAILED DESCRIPTION

The present disclosure relates to extended reality (XR). XR is an umbrella term that is used to describe various types of immersive technology, including augmented reality (AR), virtual reality (VR), mixed reality (MR), and cinematic reality (CR), among others. Generally speaking, XR technologies allow virtual world (e.g., digital) objects to be brought into “real” (e.g., non-virtual) world environments and also allow real world objects to be brought into virtual environments (e.g., via overlays or other mechanisms). XR technologies may have applications in fields including gaming, medicine, architecture, real estate, sports training, television and film, engineering, travel, and others. As such, immersive experiences that rely on XR technologies are continuing to grow in popularity. As XR technology improves, there has been an increasing effort to make the user XR experience more realistic. For instance, XR technology, in addition to being used to insert visible and/or audible virtual objects into XR media, is also being used to support manipulation of physical objects (e.g., by activating actuators that introduce physical motion, tactile effects, temperature changes, and the like) located in the proximity of the user or even located remotely from the user. Additionally, there has been an increasing effort to improve various aspects of the use of XR technology in various contexts. The present disclosure describes various techniques for enhancing various aspects of XR interactions within the context of XR experiences, thereby supporting improved user experiences.

In one example, the present disclosure describes enhancement of XR experiences. In one example, enhancement of an XR experience may be based on enhancement of XR interactions within the context of the XR experience. In one example, enhancement of an XR experience based on enhancement of XR interactions within the context of the XR experience may be based on replication of XR interactions (e.g., based on on-demand printing of objects for use in XR interactions within the context of the XR experience). In one example, enhancement of an XR experience based on enhancement of XR interactions within the context of the XR experience may be based on calibration of XR interactions (e.g., based on collection of feedback information from haptic wearables and objects based on XR interactions between the haptic wearables and the objects and processing of the feedback information for improving haptic information and/or object information which is used as reference information for supporting XR interactions within the context of XR experiences). In one example, enhancement of an XR experience based on enhancement of XR interactions within the context of the XR experience may be based on use of artificial intelligence (e.g., to provide additional information which may be used to improve replication of XR interactions, to provide additional information which may be used to improve calibration of XR interactions, to evaluate XR interactions and/or improvements to XR interactions, and the like). It will be appreciated that various other functions may be supported to provide enhancement of XR experiences based on enhancement of XR interactions within the context of XR experiences.

In one example, enhancement of an XR experience based on enhancement of XR interactions within the context of the XR experience may be based on replication of XR interactions. The enhancement of XR interactions may include enhancement of XR interactions based on a determination of a delta between an expected XR interaction and an actual XR interaction (e.g., for an object type, a haptic device type, and the like) and initiating an action for enhancing the XR interaction from the actual XR interaction to the expected XR interaction based on printing of an object to be used within the context of the XR interaction. The determination of the delta between the expected XR interaction and the actual XR interaction may include obtaining the properties of the object in the XR interaction, the capabilities of the haptic gloves used to interact with the object in the XR interaction, and determining the delta between the expected XR interaction and the actual XR interaction based on the properties of the object in the XR interaction and the capabilities of the haptic gloves used to interact with the object in the XR interaction. The action for enhancing the XR interaction from the actual XR interaction to the expected XR interaction based on printing of the object to be used within the context of the XR interaction may include sending a signal to a three-dimensional (3D) printer to cause the 3D printer to print a new object to be used within the context of the XR interaction. The enhancement of XR interactions may include use of AI to provide additional information which may be used as a basis to determine the delta between an expected XR interaction and an actual XR interaction and to initiate an action for enhancing the XR interaction from the actual XR interaction to the expected XR interaction based on printing of an object to be used within the context of the XR interaction (e.g., providing experience-specific information which may be configured to improve the XR experience across users, providing wearable-specific information for various haptic wearables, providing object-specific information for various types of objects, providing user-specific which may be configured to improve the XR experience for individual users in an individualized manner, and the like). The enhancement of XR interactions thereby supports enhancement of XR interactions where such XR interactions are based on XR systems calibrated in this manner. It will be appreciated that these and various other features and functions may be provided for supporting enhancement of XR interactions based on replication of XR interactions.

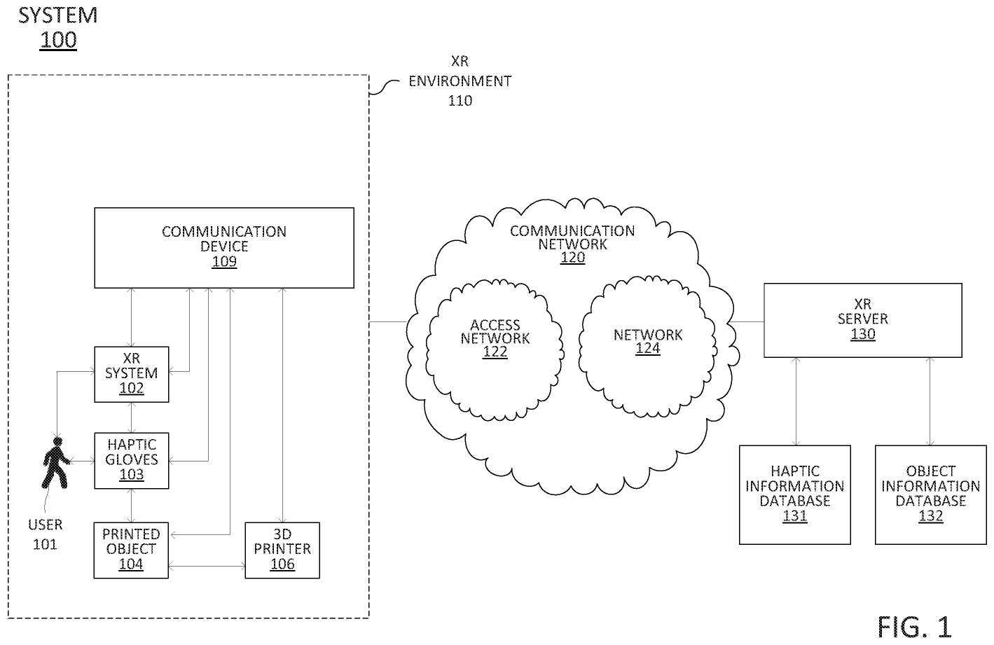

In one example, enhancement of an XR experience based on enhancement of XR interactions within the context of the XR experience may be based on calibration of the XR interactions. The enhancement of XR interactions may include enhancement of XR interactions based on XR interaction feedback information generated based on interaction between a haptic glove (or other haptic wearable(s)) and an object within the context of an XR application. The XR interaction feedback information may include haptic feedback information generated by the haptic glove based on interaction by the haptic glove with the object within the context of the XR application, object feedback information generated by the object or on behalf of the object (e.g., by one or more sensors embedded within, attached to, or otherwise associated with the object) based on interaction by the haptic glove with the object within the context of the XR application, and so forth. The enhancement of XR interactions may include updating a haptic information database which is used by haptic wearable devices (e.g., the haptic glove or other wearables) for XR interactions. The enhancement of XR interactions may include updating an object database which is used by XR systems for XR interactions. The enhancement of XR interactions may include use of AI to evaluate various types of feedback information obtained based on XR interactions for various purposes (e.g., enhancing haptic information of a haptic information database and/or object information of an object information database based on the feedback information, evaluating or scoring XR interactions based on the feedback information, and the like). The enhancement of XR interactions thereby supports enhancement of XR interactions where such XR interactions are based on XR systems calibrated in this manner. It will be appreciated that these and various other features and functions may be provided for supporting enhancement of XR interactions based on calibration of XR interactions. These and other aspects of the present disclosure are described in greater detail below in connection with the examples of FIGS. 1-5.

FIG. 1 illustrates an example system for supporting enhancement of XR interactions. The system 100 of FIG. 1 is configured to support enhancement of XR interactions. As depicted in FIG. 1, the system 100 includes an XR environment 110, a communication network 120, and an extended reality (XR) server 130. The XR environment 110 includes a user 101, an XR system 102, a pair of haptic gloves 103, a printed object 104, a three-dimensional (3D) printer 106, and a communication device 109. The communication network 120 includes an access network 122 and a network 124. The XR server 130 has associated therewith a haptic information database 131 and an object information database 132. The operation of the various elements of the system 100 is discussed further below.

In one example, the user 101 is a user of a XR system 102. The user 101 may use the XR system 102 for various XR experiences which may be supported by the XR system 102. For example, XR experiences may include XR entertainment and gaming experiences, XR learning experiences (e.g., immersive learning, remote learning, and the like), XR training experiences (e.g., training to use specific tools, medical training, and the like), XR healthcare experiences (e.g., visualizing complex surgeries, performing remote medical procedures, and the like), XR marketing experiences, and so forth. The XR system 102 may include a user interface through which the user 101 may interact with the XR system 102 (e.g., select an XR experience that the user would like to initiate, perform configurations related to XR experiences available through the XR system 102, and so forth). The user 101 may use the haptic gloves 103 for various XR interactions which may be performed by the user 101 within the context of XR experiences available to the user 101 through the XR system 102). The user 101 may use the haptic gloves 103 for XR interactions which may be independent of handling of objects by the user 101 using the haptic gloves 103 or which are based on handling of objects (e.g., the printed object 104 or other suitable objects) by the user 101 using the haptic gloves 103. The user 101 may perform various other actions within the XR environment 110 for participating in various XR experiences which may be supported by the XR system 102.

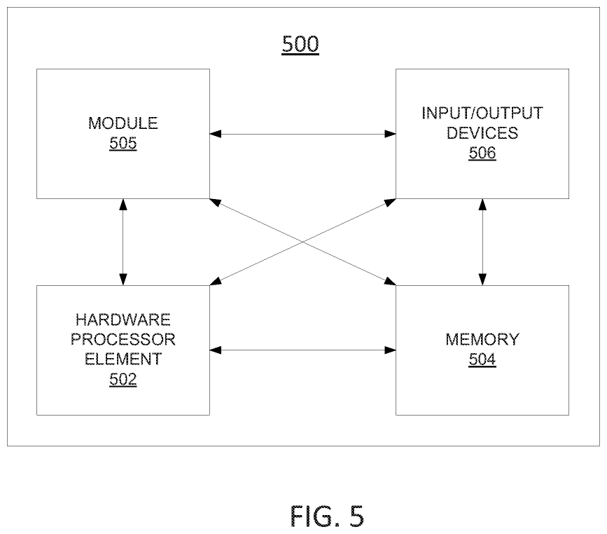

In one example, the XR system 102 may include one or more user interfaces through which the user 101 may interact with the XR system 102, including accepting input from the user 101 (e.g., selections of XR experiences by the user 101, configurations performed by the user 101, and so forth) and providing output to the user 101 (e.g., displaying XR experiences available to the user 101, information describing XR experiences available to the user 101, providing information related to XR experiences selected or completed by the user 101, and so forth). The XR system 102 may interact with various elements within the XR environment 110 in order to provide various XR experiences for the user 101. For example, the XR system 102 may interact with the haptic gloves 103 (e.g., directly where there is a direct connection of the haptic gloves 103 to the XR system 102 and/or indirectly via the communication device 109), thereby enabling the user 101 to interact with the XR system 102 using the haptic gloves 103 (e.g., for controlling selection XR experiences, for using the haptic gloves 103 within the context of XR experiences, and so forth). For example, the XR system 102 may interact with the 3D printer 106 (e.g., directly where there is a direct connection of the haptic gloves 103 to the XR system 102 and/or indirectly via the communication device 109), thereby enabling the XR system 102 (and, thus, also the user 101 via the XR system 102) to control various aspects of printing the printed object 104. The XR system 102 also may interact with the XR server 130, via communication network 120, in order to support various XR experiences for the user 101 (e.g., where such XR experiences are controlled by the XR server 130 rather than locally at the XR system 102). The XR system 102 is communicatively connected to the communication device 109 to support communications of the XR system 102 with other elements located locally within the XR environment 110 and with the XR server 130. In one example, the XR system 102 includes a computing device or processing system, such as computing system 500 depicted in FIG. 5, and, thus, may be configured to provide one or more operations or functions for supporting enhancement of XR interactions as discussed herein.

In one example, the haptic gloves 103 are configured to enable the user 101 to participate in various XR experiences. For example, the user 101 may use the haptic gloves 103 for selecting and initiating XR experiences, for participating in XR experiences (e.g., based on handling of the printed object 104), and so forth. The haptic gloves 103 may be configured to support various aspects of enhancement of XR interactions. The haptic gloves 103 may be configured to support generation of haptic feedback information based on interaction between the haptic gloves 103 and the printed object 104 as the user 101 handles the printed object 104 with the haptic gloves 103 within the context of XR experiences. The haptic gloves 103 may be configured to provide the haptic feedback information to one or more elements (e.g., the XR system 102, the XR server 130, and so forth) for processing of the haptic feedback information for use in supporting enhancement of XR interactions (e.g., for determination of haptic information for the haptic gloves 103 and storage of the haptic information for the haptic gloves 103 in the haptic information database 131). The haptic gloves 103 may be configured to collect haptic feedback information based on embedding of one or more sensors (omitted for purposes of clarity) within the haptic gloves 103. The haptic gloves 103 may be configured to support various other functions configured to support enhancement of XR interactions. It will be appreciated that, although primarily presented with respect to use of a pair of haptic gloves 103, in at least some examples only a single haptic glove may be used. It will be appreciated that, although primarily presented with respect to use of the haptic gloves 103 for supporting XR experiences for the user 101, various other types of haptic wearables (e.g., body suits, glasses, shoes, boots, socks, and so forth) may be used (e.g., in addition to or in place of the haptic gloves 103) for supporting XR experiences for the user 101 and enhancement of XR interactions for improving XR experiences for users. In one example, the haptic gloves 103 include a computing device or processing system, such as computing system 500 depicted in FIG. 5, and, thus, may be configured to provide one or more operations or functions for supporting enhancement of XR interactions as discussed herein.

In one example, the printed object 104 is configured to enable the user 101 to participate in various XR experiences. For example, the user 101 may handle the printed object 104 with the haptic gloves 103 while participating in XR experiences. The printed object 104 may be configured to support various aspects of enhancement of XR interactions. The printed object 104 may be configured to support generation of object feedback information based on interaction between the printed object 104 and the haptic gloves 103 as the user 101 handles the printed object 104 with the haptic gloves 103 within the context of XR experiences. The printed object 104 may be configured to collect object feedback information based on embedding of one or more sensors (e.g., temperature sensors, motion sensors, accelerometers, and so forth, which have been omitted for purposes of clarity) within the printed object 104 (e.g., during or after printing of the printed object 104 by the 3D printer 106). The printed object 104 (and/or the haptic gloves 103) may be configured to provide the object feedback information to one or more elements (e.g., the XR system 102, the XR server 130, and so forth) for processing of the object feedback information for use in supporting enhancement of XR interactions (e.g., for determination of object information for the printed object 104 and storage of the object information for the printed object 104 in the object information database 132). The printed object 104 may be configured to provide the object feedback information to the one or more elements based on embedding of one or more communication elements (e.g., Bluetooth communication elements, WiFi communication elements, cellular communication elements, and so forth, which have been omitted for purposes of clarity) within the printed object 104 (e.g., during or after printing of the printed object 104 by the 3D printer 106). The printed object 104 may be considered to be an Internet of Things (IoT) object (e.g., based on embedding of one or more IoT elements therein or association of one or more IoT elements therewith). The printed object 104 may be configured to support various other functions configured to support enhancement of XR interactions. It will be appreciated that, although primarily presented with respect to printing of a single printed object 104, in at least some examples multiple printed objects may be printed within the context of XR experiences for refining various aspects of XR interactions during enhancement of XR interactions (e.g., printing the same printed object 104 multiple times with variations to obtain refined object feedback information which may support enhancement of XR interactions). It will be appreciated that, although primarily presented with respect to use of the printed object 104 for supporting XR experiences for the user 101, various other types of objects and elements (e.g., actual objects, virtual objects, and so forth) may be used (e.g., in addition to or in place of the printed object 104) for supporting XR experiences for the user 101 and enhancement of XR interactions for improving XR experiences for users. In one example, the printed object 104 includes a computing device or processing system, such as computing system 500 depicted in FIG. 5, and, thus, may be configured to provide one or more operations or functions for supporting enhancement of XR interactions as discussed herein.

In one example, the 3D printer 106 is configured to print the printed object 104. The 3D printer 106 may print the printed object 104 on demand in response to a request to print the printed object 104. The request to print the printed object 104 may be provided by the XR system 102, the XR server 130, and so forth. The 3D printer 106 may be configured to print the printed object 104 such that the printed object 104 has the ability to house one or more sensors (omitted for purposes of clarity) associated therewith, where the one or more sensors may be configured to support collection of object feedback information by the printed object 104. The 3D printer 106 may be configured to embed or otherwise associate one or more sensors (e.g., temperature sensors, motion sensors, accelerometers, and so forth, which have been omitted for purposes of clarity) within the printed object 104 (e.g., during or after printing of the printed object 104 by the 3D printer 106) for enabling the printed object 104 to support collection of object feedback information. The 3D printer 106 may be configured to embed or otherwise associate one or more communication elements (e.g., Bluetooth communication elements, WiFi communication elements, cellular communication elements, and so forth, which have been omitted for purposes of clarity) within the printed object 104 (e.g., during or after printing of the printed object 104 by the 3D printer 106) for enabling the printed object 104 to support communication of object feedback information. The 3D printer 106 may be configured to support various other functions configured to support enhancement of XR interactions. It will be appreciated that, although primarily presented with respect to printing of a single printed object 104, in at least some examples multiple printed objects may be printed within the context of XR experiences for refining various aspects of XR interactions during enhancement of XR interactions (e.g., printing the same printed object 104 multiple times with variations to obtain refined object feedback information which may support enhancement of XR interactions). In one example, the 3D printer 106 includes a computing device or processing system, such as computing system 500 depicted in FIG. 5, and, thus, may be configured to provide one or more operations or functions for supporting enhancement of XR interactions as discussed herein.

In one example, the communication device 109 is configured to support communications of the XR environment 110. The communication device 109 is configured to support communications between elements located at the XR environment 110. For example, the communication device 109 may support communications between the XR system 102 and the haptic gloves 103 (e.g., for enabling the user 101 to participate in XR experiences using the haptic gloves 103, for supporting feedback of haptic feedback information from the haptic gloves 103 to the XR system 102, and so forth), between the XR system 102 and the printed object 104, between the XR system 102 and the 3D printer 106 (e.g., for controlling printing of the printed object 104), and so forth. The communication device 109 is configured to support communications between elements located at the XR environment 110 and the XR server 130 via the communication network 120. For example, the communication device 109 may support communications between the XR system 102 and the XR server 130 (e.g., for supporting XR experiences for the user 101, for supporting enhancement of XR interactions, and so forth), between the haptic gloves 103 and the XR server 130 (e.g., for enabling the user 101 to participate in XR experiences using the haptic gloves 103, for supporting feedback of haptic feedback information from the haptic gloves 103 to the XR server 130, and so forth), between the printed object 104 and the XR server 130, between the 3D printer 106 and the XR server 130 (e.g., for controlling printing of the printed object 104), and so forth. The communication device 109 may support communications via the communication network 120 based on various types of communication technologies which may depend on the manner in which the communication device 109 accesses the access network 122 of the communication network 120 (e.g., wired access technologies, wireless access technologies, and so forth). In one example, the communication device 109 includes a computing device or processing system, such as computing system 500 depicted in FIG. 5, and, thus, may be configured to provide one or more operations or functions for supporting enhancement of XR interactions as discussed herein.

In one example, the communication network 120 may include any one or more types of communication networks which may support enhancement of XR interactions. For example, the communication network 120 may include a wireline network, such as a traditional circuit switched network (e.g., a public switched telephone network (PSTN)), a packet network (e.g., an Internet Protocol (IP) network (e.g., an IP Multimedia Subsystem (IMS) network), an asynchronous transfer mode (ATM) network, a Voice over IP (VoIP) network, a Service over IP (SoIP) network, and the like), and so forth. For example, the communication network 120 may include a wireless network, such as a cellular network (e.g., a Second Generation (2G) network, a Third Generation (3G) network, a Fourth Generation (4G) network, a long term evolution (LTE) network, a Fifth Generation (5G) network, and the like), a satellite network, a WiFi network, and so forth. The communication network 120 may support communications between devices in the XR interaction environment 110 (e.g., the XR system 102, the haptic gloves 103, the printed object 104, the 3D printer 106, the communication device 109, and so forth) and the XR server 130 to support enhancement of XR interactions in accordance with the present disclosure. The communication network 120, as indicated above, includes the access network 122 and the network 124.

In one example, the access network 122 may include a broadband cable access network, a broadband optical access network, a Local Area Network (LAN), a wireless access network (e.g., an IEEE 802.11/Wi-Fi network and the like), a cellular access network (e.g., 2G, 3G, 4G, LTE, 5G, and so forth), a Digital Subscriber Line (DSL) network, a PSTN access network, a third-party network, and the like.

In one example, the network 124 may include a telecommunication service provider network, a core network, an enterprise network including infrastructure for computing and providing communications services of a business, an educational institution, a governmental service, an enterprise, and so forth. In one example, the network 124 may combine core network components of a cellular network with components of a triple play service network; where triple-play services include telephone services, Internet or data services, and television services to subscribers. For example, the network 124 may functionally include a fixed mobile convergence (FMC) network, e.g., an IP Multimedia Subsystem (IMS) network. In addition, the network 124 may functionally include a telephony network, e.g., an Internet Protocol/Multiprotocol Label Switching (IP/MPLS) backbone network utilizing Session Initiation Protocol (SIP) for circuit-switched and Voice over internet Protocol (VoIP) telephony services. In one example, the network 124 may further include a broadcast television network, e.g., a traditional cable provider network or an Internet Protocol Television (IPTV) network, as well as an Internet Service Provider (ISP) network. In one example, the network 124 may include a plurality of television (TV) servers (e.g., a broadcast server, a cable head-end), a plurality of content servers, an advertising server (AS), an interactive TV/video on demand (VoD) server, and so forth.

In one example, the communication network 120 may be operated by a telecommunication network service provider. The operator of the communication network 120 may provide various services to subscribers via the communication network 120. For example, the operator of the communication network 120 may provide a cable television service, an IPTV service, or any other types of telecommunication services to subscribers via the access network 122 and the network 124. It will be appreciated that, although primarily described with respect to examples in which the communication network 120 is operated by a single service provider, the access network 122 and the network 124 may be operated by different service providers, either or both of the access network 122 and the network 124 may be operated by entities having core businesses unrelated to telecommunications services (e.g., corporate, governmental, or educational institution LANs, and the like), and so forth.

The XR server 130 may be configured to support various functions for supporting enhancement of XR interactions. For example, the XR server 130 may be configured to maintain XR experience information (e.g., XR experience control information, object property information, haptic wearable capability information, and the like) for use in providing various types of XR experiences (e.g., XR-based gaming, XR-based education, XR-based training, XR-based telemedicine, and the like). For example, the XR server 130 may be configured to support replication of XR interactions for improving XR experiences (e.g., maintaining XR experience control information (which may include XR experience story information, XR interaction control information for controlling various aspects of XR interactions, and the like), controlling collection of object property information and haptic wearable capability information, analyzing object property information and haptic wearable capability information for XR interactions, controlling collection of haptic wearable feedback information and object feedback information associated with XR interactions, controlling initiation of actions for replication of XR interactions, and the like). For example, the XR server 130 may be configured to support calibration of XR interactions for improving XR experiences (e.g., maintaining XR experience control information (which may include XR experience story information, XR interaction control information for controlling various aspects of XR interactions, and the like), maintaining XR interaction control information, controlling collection of XR interaction feedback information including haptic wearable feedback information and object feedback information, analyzing haptic wearable feedback information and object feedback information for XR interactions, controlling modification of XR interaction control information based on XR interaction feedback information, and the like). It will be appreciated that the XR server 130 may be configured to support various other functions for providing enhanced XR experiences. In one example, the XR server 130 includes a computing device or processing system, such as computing system 500 depicted in FIG. 5, and, thus, may be configured to provide one or more operations or functions for supporting enhancement of XR interactions as discussed herein.

The haptic information database 131 may store various types of haptic information. The haptic information maintained in the haptic information database 131 may include haptic wearable device type capability information for haptic wearable device types (e.g., for a particular haptic wearable device type, a description of the haptic capabilities expected for haptic wearable devices of the haptic wearable device type). The haptic information maintained in the haptic information database 131 may include haptic wearable device capability information for haptic wearable devices (e.g., for specific haptic wearable devices, such as haptic gloves 103, which may be of a particular device type, brand, model, and the like), where such haptic wearable device capability information may include haptic wearable device capabilities for the haptic wearable device based on the haptic wearable device type of the haptic wearable device, haptic wearable device capabilities specific to the haptic wearable device which may be in addition to or modifications of haptic wearable device capabilities of the haptic wearable device type of the haptic wearable device, and the like. It will be appreciated that the haptic information database 131 may include various other types of information which may describe or otherwise be related to haptic wearable devices such as the haptic gloves 103 and various other haptic wearable devices which may be utilized within the context of XR experiences.

The object information database 132 may store various types of object information. The object information maintained in the object information database 132 may include object type property information for object types (e.g., for a particular object type, a description of the object properties expected for objects of the object type). The object information maintained in the object information database 132 may include object property information for objects (e.g., for specific objects, such as printed object 104), where such object information may include object type properties for the object based on the object type of the object, properties specific to the object which may be in addition to or modifications of object type properties of the object type of the object, and the like. It will be appreciated that the object information database 132 may include various other types of information which may describe or otherwise be related to objects such as the printed object 104 and various other objects which may be utilized within the context of XR experiences.

It will be appreciated that the system 100 has been simplified and, thus, that the system 100 may be implemented in a different form than that which is illustrated in FIG. 1. For example, the system 100 may be expanded by including additional elements, devices, networks, providers, and so forth, without altering the scope of the present disclosure. For example, the system 100 may be altered to omit various elements, substitute elements for other elements that perform the same or similar functions, combine elements that are illustrated as separate elements, and/or implement elements as functions that are spread across several devices that operate collectively as the respective elements, without altering the scope of the present disclosure. For example, the system 100 may be altered by providing various functions on one or more of end user devices (e.g., smart phones, wearable devices, or the like), mobile edge computing (MEC) devices (e.g., using mobile edge hosts and so forth), communication network devices (e.g., application servers and so forth), and the like, as well as various combinations thereof. It will be appreciated that the system 100 may be modified in various other ways while still supporting enhancement of XR experiences. Therefore, these and various other modifications are all contemplated within the scope of the present disclosure.

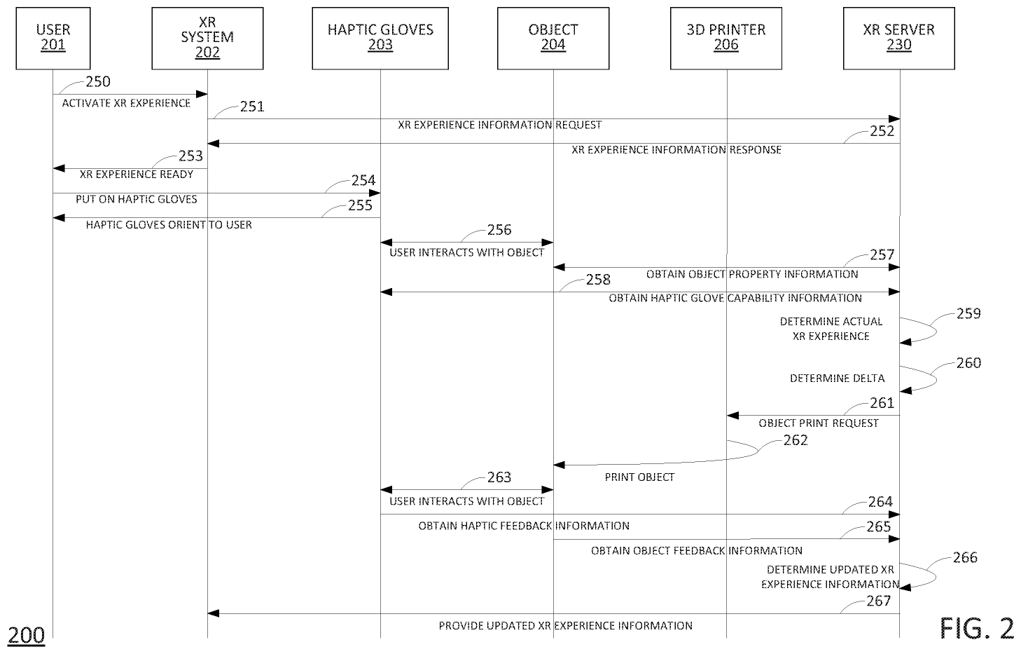

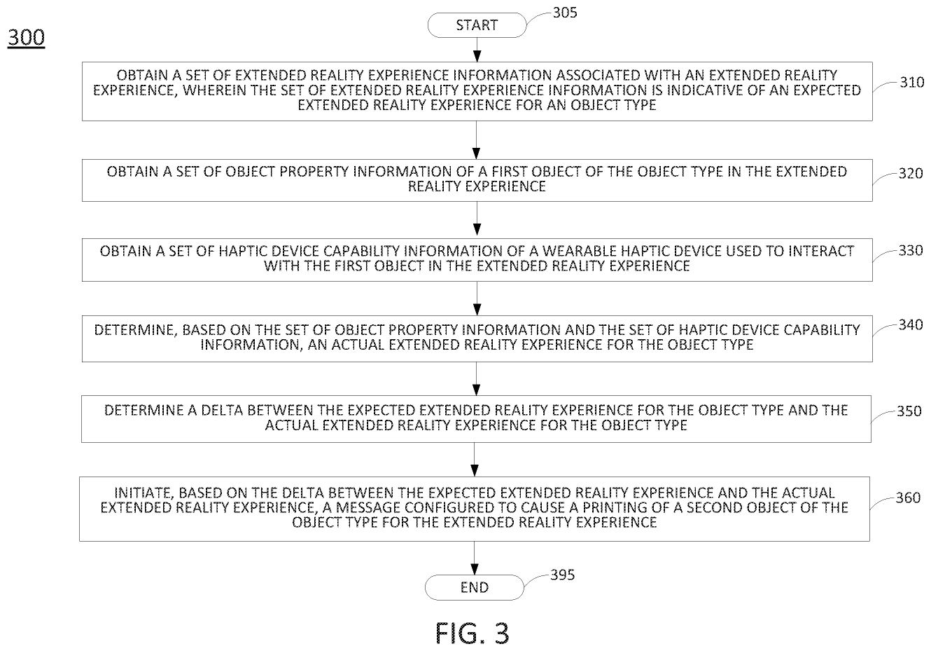

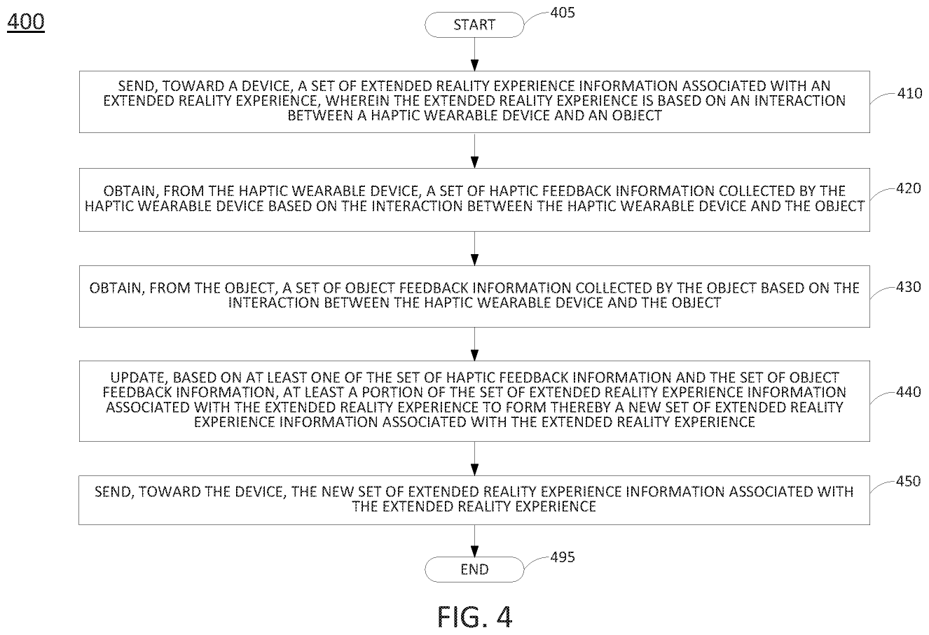

It is noted that various features discussed in conjunction with FIG. 1 may be further understood from the example methods of FIG. 2, FIG. 3, and FIG. 4. FIG. 2 illustrates a flowchart of an example method for supporting enhancement of XR interactions. The example method 200 is depicted within the context of a system configured to support XR experiences for a user 201. Namely, the system includes an XR system 202, a pair of haptic gloves 203, an object 204, a 3D printer 206, and an XR server 230. It will be appreciated that the system depicted in FIG. 2 may correspond to the system 100 of FIG. 1 (e.g., XR system 202 may correspond to XR system 102, haptic gloves 203 may correspond to haptic gloves 103, 3D printer 206 may correspond to 3D printer 106, and XR server 230 may correspond to XR server 130). It will be appreciated that the haptic gloves 203 may include any wearable device or devices which may be used by the user 201 to partake in the XR experience (e.g., goggles, a glove or pair of gloves, or the like, as well as various combinations thereof). It will be appreciated that the object 204 represents the current object with which the user 201 may interact and, thus, may change over the course of execution of the method 200 (e.g., from an initial object with which the user 201 initially interacts to a printed object which is printed by the 3D printer 206 (such as printed object 104 of FIG. 1)). It will be appreciated that various elements of FIG. 1 which are omitted from FIG. 2 for purposes of clarity also may be used within the context of FIG. 2.

At step 250, the user 201 activates an XR experience. The user 201 may activate the XR experience based on interaction with the XR system 202. The user 201 may activate the XR experience based on interaction with a user interface of the XR system 202, such as where a user uses a touchscreen to browse a list of available XR programs and to launch one of the XR programs. For example, the user 201 may activate an XR game, an XR training program, or the like.

At step 251, the XR system 202 sends a request for XR experience information to the XR server 230. At step 252, the XR server 230 responds to the request for XR experience information from the XR system 202 by sending the XR experience information to the XR system 202. The XR experience information includes information configured to enable the user 201 to partake in an XR experience (e.g., the XR experience provided by the XR program selected and activated by the user 201 at step 251). The XR experience information may vary for different types of XR experiences (e.g., XR games, XR training programs, and the like).

In one example, the XR experience information may include XR experience control information (which may include XR experience story information, XR interaction control information for controlling various aspects of XR interactions, and the like), object property information for various objects associated with the XR experience, haptic wearable capability information associated with various haptic wearables which may be used within the context of the XR experience, and the like. For example, in the case of an XR game, the XR experience information may include XR game information which may be used by the XR system 202 to render the XR game for the user 201 and to enable the user 201 to play the XR game and interact within the context of the XR game (e.g., the overall storyline of the game, details about the game world, the progress of the user 201 in the game, options for XR interactions by the user 201 within the context of the game, and the like). For example, in the case of an XR training program, the XR experience information may include XR training program information which may be used by the XR system 202 to render the XR training program for the user 201 and to enable the user 201 to use the XR training program for training purposes (e.g., information for training to perform a surgery such as surgical procedures, guidelines, illustrations, animations, pictures, diagrams, etc., information for training for a type of sport such as exercise routines, illustrations, animations, pictures, diagrams, training equipment, or the like).

In one example, the XR experience information may include information that is indicative of an expected extended reality experience that is expected to be provided to the user 201. The XR experience information may include information that is indicative of an expected extended reality experience for an object type (e.g., an object type of the object 204 with which the user 201 will interact, in an XR interaction based on the haptic gloves 203, within the context of the XR experience). For example, within the context of an XR game, the XR experience information may include, for a sword to be wielded by the user 201 within the XR game, information indicative that the sword is supposed to have a particular texture on the handle, a particular weight, a particular weight distribution, and the like, in order for the user 201 to experience the XR interaction with the object 204 in the manner intended or expected for the XR game. For example, within the context of an XR training program which enables surgeons to train for heart surgery, the XR experience information may include, for a heart to be handled by the user 201 within the XR training program, information indicative that the heart is supposed to have a particular size, shape, texture, and the like, in order for the user 201 to experience the XR interaction with the object 204 in the manner intended or expected for the XR training program.

The XR server 230 may obtain the XR experience information from various sources. For example, the XR server 230 may obtain the XR experience information from one or more databases or elements, such as a story database, an objects database, a haptics database, physics engine, and the like.

At step 253, the XR system 202 informs the user 201 that the XR experience is ready. The XR system 202 may present this information to the user 201 via a user interface of the XR system 202. For example, the XR system 202 may inform the user 201 that the XR game is ready to be played, inform the user 201 that the training program is ready to be used, and the like.

At step 254, the user 201 puts on the haptic gloves 203. It will be appreciated that, although omitted for purposes of clarity, the user 201 may also put on one or more other wearable haptic devices which may be used to provide the XR experience (e.g., goggles, a bodysuit, socks, shoes, and the like).

At step 255, the haptic gloves 203 adjust to the user 201. The haptic gloves 203 may adjust to the user by setting or modifying one or more parameters (e.g., sensitivity of the haptic gloves to inputs, or fit of the haptic gloves in terms of tightness or looseness, and so on) of the haptic gloves 203 based on one or more characteristics of the user 201.

At step 256, the user 201 interacts with the object 204 using the haptic gloves 203. The object 204 may be a virtual object within the context of the XR experience or a physical object. For example, in an XR game the object may be a sword, in an XR training program the object may be a tool (e.g., a scalpel in surgery) or an element to be manipulated by the tool (e.g., an organ such as a heart or a body part in surgery), and the like.

At step 257, the XR server 230 obtains object property information of the object 204. The XR server 230, as illustrated, may obtain the object property information by requesting the object property information from the object 204 and receiving the object property information from the object 204. It will be appreciated that the XR server 230 also or alternatively may obtain the object property information from one or more other sources, such as from the XR system 202, an object information database associated with the XR server 230 (e.g., based on an object type of the object 204, based on an indication of an XR experience with which the object 204 is associated, and the like), and the like. The object property information may include various types of properties which may be used to support the XR experience (e.g., for rendering of the object 204 as a virtual object within the XR experience, for controlling the XR experience based on properties of the object where the object 204 is a virtual object or a physical object, and the like). For example, the object property information for the object 204 may include information related to object properties such as object type, shape, size, dimensionality, appearance, weight, texture, sound, smell, structural variances, capabilities, and the like. The object property information may include information for various other types of object properties which may be used to describe or characterize the object 204 and, thus, which may support the actual XR experience that is provided to the user 201.

At step 258, the XR server 230 obtains haptic glove capability information of the haptic gloves 203. The XR server 230, as illustrated, may obtain the haptic glove capability information by requesting the haptic glove capability information from the haptic gloves 203 and receiving the haptic glove capability information from the haptic gloves 203. It will be appreciated that the XR server 230 also or alternatively may obtain the haptic glove capability information from one or more other sources, such as from the XR system 202, a haptic information database associated with the XR server 230 (e.g., based on type of haptic gloves 203 being used, based on an indication of an XR experience with which the haptic gloves 203 are being used, and the like), and the like. The haptic glove capability information may include various types of capabilities which may be used to support the XR experience (e.g., for enabling the user 201 to experience the interaction with the object 204, as a virtual object or a physical object in a realistic manner). For example, haptic glove capability information for the haptic gloves 203 may include information related to haptic glove capabilities such as capabilities which enables the user 201 to feel hardness, softness, wetness, stickiness, temperature, vibrations, tactile forces, and the like. The haptic glove capability information may include information for various other types of capabilities which may be supported by the haptic gloves 203 and, thus, which may support the actual XR experience that is provided to the user 201.

At step 259, the XR server 230 determines the actual XR experience that is experienced by the user 201. The XR server 230 may determine the actual XR experience that is experienced by the user 201 based on the object property information of the object 204 (e.g., based on a determination that the object 204 has certain properties that are experienced by the user 201 within the context of the XR experience) and/or the haptic glove capability information of the haptic gloves 203. For example, the XR server 230 may determine the actual XR experience that is experienced by the user 201, based on the object property information of the object 204 and the haptic glove capability information of the haptic gloves 203, based on a determination that the object 204 has certain properties that are being experienced by the user 201 within the context of the XR experience and a determination that the haptic gloves 203 supports certain capabilities that enable the user 201 to experience the object 204 in a certain way within the context of the XR experience. For example, within the context of an XR game this may be a determination, for a sword wielded by the user 201 within the XR game, that the user 201 is experiencing a particular texture on the handle and a particular weight and weight distribution (e.g., due to the object properties of the object 204 and the haptic glove capabilities supported by the haptic gloves 203). For example, within the context of an XR training program which enables surgeons to train for heart surgery this may be a determination, for a heart handled by the user 201 within the XR training program, that the user 201 is experiencing a particular size, weight, and texture (e.g., due to the object properties of the object 204 and the haptic glove capabilities supported by the haptic gloves 203).

At step 260, the XR server 230 determines a delta between the expected XR experience and the actual XR experience. The delta between the expected XR experience and the actual XR experience may be an overall delta between the expected XR experience and the actual XR experience, a delta between the expected XR experience and the actual XR experience for a particular XR interaction or XR interaction type (e.g., for a particular object or object type with which the user 201 interacts in an XR interaction within the context of the XR experience), and the like.

In one example, the XR server 230 may determine the delta between the expected XR experience and the actual XR experience based on a comparison of the expected XR experience and the actual XR experience to determine one or more differences between the expected XR experience and the actual XR experience (e.g., a determination that the user 201 is actually experiencing the object 204, due to the object properties of the object 204 and the haptic device capabilities of the haptic gloves 203, in a manner that is different than the manner in which the user 201 is expected, or supposed, to be experiencing the object 204 during interaction with the object 204 in the XR experience). It will be appreciated that, here, the delta may be based on object type of the object 204, one or more aspects of the XR interaction for the object 204, and the like. In other words, this may be a determination as to whether the XR experience that the user 201 is receiving is the full XR experience that is expected or whether the object properties of the object 204 and/or the haptic capabilities of the haptic gloves 203 are limited such that the user 201 receiving something other than the full XR experience that is expected to experience when interacting with the object 204 in the XR experience. For example, within the context of an XR game this may be a determination, for a sword wielded by the user 201 within the XR game, that the sword is supposed to have a particular texture on the handle and a particular weight, neither of which are supported by the combination of the object 204 and the haptic gloves 203 (e.g., cannot be replicated by the haptic gloves 203 in a way that enables the user 201 to fully experience the texture and the weight and weight distribution when interacting with the object 204 in the X game), and that the expected XR experience may be provided to the user 201 by causing printing of a sword (to be used as a new object 204) which, when wielded by the user 201 using the haptic gloves 203, will enable the user to experience the texture and the weight and weight distribution indicated by the expected XR experience (e.g., by object type properties for the object type of the object 204). For example, within the context of an XR training program which enables surgeons to train for heart surgery this may be a determination, for a heart handled by the user 201 within the XR training program, that the heart is supposed to have a particular texture that is not supported by the combination of the object 204 and the haptic gloves 203 (e.g., cannot be replicated by the haptic gloves 203 in a way that enables the user 201 to fully experience the texture), and that the expected XR experience may be provided to the user 201 by causing printing of a replica or model of a heart (to be used as a new object 204) which, when wielded by the user 201 using the haptic gloves 203, will enable the user to experience the texture indicated by the expected XR experience (e.g., by object type properties for the object type of the object 204).

In one example, the XR server 230 may determine the delta between the expected XR experience and the actual XR experience for an object type. In one example, the XR server 230 may determine the delta between the expected XR experience and the actual XR experience for the object type by determining, based on the set of XR experience information associated with an XR experience, a set of object type property information for the object type (e.g., object properties for the object type of the object 204 in general, or for the object type of the object 204 or for the object 204 specifically within the context of the XR experience) that is indicative of a manner in which the user 201 is expected to experience interaction with the object 204 in the XR experience, determining, based on the actual XR experience, a set of actual object interaction properties experienced by the user 201 during the XR experience, and determining, based on the set of object type property information for the object type and the set of actual object interaction properties experienced during the XR experience, the delta between the expected XR experience for the object type and the actual XR experience for the object type. The delta between the expected XR experience for the object type and the actual XR experience for the object type may be represented in various ways. In one example, the delta between the expected XR experience for the object type and the actual XR experience for the object type may be represented in the form of one or more object properties to be satisfied in a new object 204 to be created for the user 201 in order to shift the user 201 from the actual XR experience to the expected XR experience. In one example, the delta between the expected XR experience for the object type and the actual XR experience for the object type may be represented in the form of one or more haptics capabilities or settings to be applied on the haptic gloves 203 in order to shift the user 201 from the actual XR experience to the expected XR experience. It will be appreciated that the XR server 230 may determine the delta between the expected XR experience for the object type and the actual XR experience for the object type in various other ways, may represent the delta between the expected XR experience for the object type and the actual XR experience for the object type in various other ways, and the like.

At step 261, the XR server 230 initiates, based on the delta between the expected XR experience and the actual XR experience, a message configured to cause the 3D printer 206 to print a new object 204 for use by the user 201 within the XR experience. At step 262, the 3D printer 206 prints the new object 204 for use by the user 201 within the XR experience. For example, within the context of an XR game in which the object 204 was a sword (virtual or physical), the XR server 230 may instruct the 3D printer 206 to print a sword having the particular texture on the handle and the particular weight and weight distribution (e.g., since the capabilities of the haptic gloves 203 and object properties of the initial object 204 were insufficient to enable the haptic gloves 203 to give the user 201 the proper XR experience for the sword), such that the user 201 may use the haptic gloves 203 to interact with the printed sword in a manner that improves the XR experience of the user 201. For example, within the context of an XR training program which enables surgeons to train for heart surgery, the XR server 230 may instruct the 3D printer 206 to print a replica of a heart having the particular texture (e.g., since the capabilities of the haptic gloves 203 and the object properties of the initial object 204 were insufficient to enable the haptic gloves 203 to give the user 201 the proper XR experience for the heart), such that the user 201 may use the haptic gloves 203 to interact with the printed heart in a manner that improves the XR experience of the user 201. It will be appreciated that, although omitted from FIG. 2 for purposes of clarity, one or more additional actions related to the printing of the new object 204 may be performed (e.g., notifying the user 201 of the availability of the new object 204 for use within the XR experience, automatically providing the new object 204 to the user 201 for use within the XR experience (e.g., delivering the new object 204 to the user by an autonomous vehicle such as a drone, launching the new object 204 to the user 201 or to a vicinity of the user, and the like), and so forth).

At step 263, the user 201 interacts with the new object 204 using the haptic gloves 203. For example, within the context of the XR game where the new object 204 that was printed is a sword, the user 201 may use the haptic gloves 203 to hold the sword and use it within the XR game. For example, within the context of the XR training program where the new object 204 that was printed was a heart, the user 201 may use the haptic gloves to hold the heart and use it within the XR training program.

At step 264, the XR server 230 obtains haptic feedback information collected by the haptic gloves 203 based on interaction by the user 201 with the new object 204 using the haptic gloves 203. The XR server 230, as illustrated, may obtain the haptic feedback information directly from the haptic gloves 203 (e.g., by requesting the haptic feedback information from the haptic gloves 203 and receiving the haptic feedback information from the haptic gloves 203). It will be appreciated that the XR server 230 also or alternatively may obtain the haptic feedback information from one or more other sources of the haptic feedback information, such as from the XR system 202, the new object 204, and the like. The haptic feedback information may include various types of information which may be used by the XR server 230 to update information associated with the XR experience, such as XR experience control information for the XR experience, object property information for an object type of the object 204, haptic capability information for a haptic wearable device type of the haptic gloves 203, and the like. For example, the haptic feedback information may include measurements collected by various sensors of the haptic gloves 203 (e.g., pressure sensors, temperature sensors, accelerometers, and the like) while the user 201 interacts with the new object 204 using the haptic gloves 203. It will be appreciated that various other types of haptic feedback information may be collected and provided to the XR server 230 for use in refining various aspects of the XR experience.

At step 265, the XR server 230 obtains object feedback information collected by the new object 204 based on interaction by the user 201 with the new object 204 using the haptic gloves 203. The XR server 230, as illustrated, may obtain the object feedback information directly from the new object 204 (e.g., by requesting the object feedback information from the new object 204 and receiving the object feedback information from the new object 204). It will be appreciated that the XR server 230 also or alternatively may obtain the object feedback information from one or more other sources of the object feedback information, such as from the XR system 202, the haptic gloves 203, and the like. The object feedback information may include various types of information which may be used by the XR server 230 to update information associated with the XR experience, such as XR experience control information for the XR experience, object property information for an object type of the object 204, haptic capability information for a haptic wearable device type of the haptic gloves 203, and the like. For example, the object feedback information may include measurements collected by various sensors of new object 204 (e.g., pressure sensors, temperature sensors, accelerometers, and the like, which may be integrated with the new object 204 during printing of the new object 204 or after printing of the new object 204) while the user 201 interacts with the new object 204 using the haptic gloves 203. It will be appreciated that various other types of object feedback information may be collected and provided to the XR server 230 for use in refining various aspects of the XR experience.

At step 266, the XR server 230 determines updated XR experience information for the XR experience. The updated XR experience information may include one or more of XR experience control information for the XR experience (e.g., a story maintained in a story database, mechanics of XR interactions from a physics database, and the like), object property information for an object type (e.g., object property information which may be used within the context of the XR experience or future XR experiences for various purposes, such as controlling the XR experience that is provided, improving interpretation of signals by wearable haptic devices when handling objects of the object type, and the like), haptic capability information for a haptic wearable device type (e.g., haptic wearable capability information which may be used within the context of the XR experience or future XR experiences for various purposes, such as controlling the XR experience that is provided, improving interpretation of signals by wearable haptic devices when handling objects of the object type, and the like), and the like. The XR server 230 may determine the updated XR experience information for the XR experience based on one or more of the haptic feedback information, the object feedback information, and the like.

At step 267, the XR server 230 provides the updated XR experience information to the XR system 202 that is used to provide the XR experience for the user 201. It will be appreciated that the updated XR experience information may be provided to the XR system 202 within the context of the same XR experience of the user 201 (e.g., while the same game is being played, while the training program is still running, and the like), when the user 201 (or any other users) accesses the XR experience again in the future (e.g., the next time the user 201 plays the game, the next time the user 201 uses the training program, and the like), and so forth. In this manner, the XR experience for the user 201 is enhanced over time.

It will be appreciated that, although primarily presented with respect to specific arrangements of interactions between elements, interactions between elements may be performed in various other ways. For example, although the communications of the haptic gloves 203 and the object 204 are depicted as being directly with the XR server 230, at least some of the communications between the haptic gloves 203 and the XR server 230 may be performed via the XR system 202 and/or at least some of the communications between the object 204 and the XR server 230 may be performed via the XR system 202. For example, although the communications of the objects 204 are depicted as being directly with the XR server 230, at least some of the communications of between the objects 204 and the XR server 230 may be performed via the haptic gloves 203. It will be appreciated that other connections and data flow paths may be supported.

It will be appreciated that, although depicted as ending, steps 250 to 267 of method 200 (or subsets thereof, various combinations thereof, and the like) may continue to be repeated any suitable number of times. For example, various steps of method 200 (e.g., steps 250 to 267, steps 256 to 258, steps 263 to 267, steps 256 to 267, and so forth) may be repeated to enable training of the user 201. For example, steps 256 to 258 may be repeated with the same object 204 in order to enable the user 201 to train on the object 204 (e.g., where the object 204 to be handled by the user 201 is expected to remain consistent). For example, certain combinations of steps (e.g., steps 263 to 267, steps 256 to 267, and the like) may be repeated with slight variations of the same object 204 (e.g., changing one or more of size, shape, texture, and the like, in one or more additional iterations) in order to enable the user 201 to train on the object 204 (e.g., where the object 204 to be handled by the user 201 is expected to vary slightly over time, such as for use by a surgeon for training for heart surgery where different patients getting the same surgery may have hearts that are slightly different from each other in terms of shape, size, and so forth). It will be appreciated that training may be supported in various other ways.

For example, various steps of method 200 (e.g., steps 250 to 267, steps 256 to 258, steps 263 to 267, steps 256 to 267, and so forth) may be repeated to support refinement of the haptic gloves 203 (e.g., based on collection of information for refining information about the haptic gloves 203 that is maintained by a haptic information database). For example, steps 256 to 258 may be repeated with slightly different settings on the haptic gloves 203, while handling the same object 204, in order to enable collection of feedback information related to the operation of the haptic gloves 203. For example, certain combinations of steps (e.g., steps 263 to 267, steps 256 to 267, and the like) may be repeated with the same settings on the haptic gloves 203, while handling different versions of the object 204 (e.g., using variations in one or more of size, shape, texture, and the like), in order to enable collection of feedback information related to the operation of the haptic gloves 203. It will be appreciated that refinement of the haptic gloves 203 (e.g., based on collection of information for refining information about the haptic gloves 203 that is maintained by a haptic information database) may be supported in various other ways.

For example, various steps of method 200 (e.g., steps 250 to 267, steps 256 to 258, steps 263 to 267, steps 256 to 267, and so forth) may be repeated to support refinement of the object 204 (e.g., based on collection of information for refining information about the object 204, or object type of the object 204, that is maintained by an object database). For example, steps 256 to 258 may be repeated with slightly different settings on the haptic gloves 203, while handling the same object 204, in order to enable collection of feedback information related to the object 204. For example, certain combinations of steps (e.g., steps 263 to 267, steps 256 to 267, and the like) may be repeated with the same settings on the haptic gloves 203, while handling different versions of the object 204 (e.g., using variations in one or more of size, shape, texture, and the like), in order to enable collection of feedback information related to the object 204. It will be appreciated that refinement of the object 204 (e.g., based on collection of information for refining information about the object 204, or object type of the object 204, that is maintained by an object database) may be supported in various other ways.

It is noted that various examples discussed with respect to system 100 of FIG. 1 and method 200 of FIG. 2 may be further understood by considering various use cases as follows.

Various examples presented herein for supporting enhancement of XR interactions may support XR interactions that are perfectly or nearly perfectly replicated for local and remote interactions. For example, 3D objects printed on demand (e.g., orchestrated via the system) in any location support creation of more in-depth experiences. For example, gloves may be configured to provide feedback, resistance, or other stimulation (e.g., temperature, fluidity, crawling, torque, weight, etc.) based on an object being manipulated locally or manipulated in a virtualized environment. For example, by making a 3D printed object (e.g., a specific version or even a generalized version), detailed experiences and textures via the haptic glove may be enhanced. For example, a database of haptic interaction properties (e.g., weight, temperature, fluidity, etc.) for virtual objects to be represented across different environments may be enhanced. For example, artificial intelligence (AI) capabilities may be used to map measured properties to new experiences (e.g., blood flow to stream or the like). For example, various capabilities may be used to allow users to calibrate the remote interaction (e.g., the glove and the printed object that is handled using the glove) as well as various conditions of the remote interaction (e.g., a printed object can exhibit expected conditions in the process, as optimized by AI analysis). It will be appreciated that use of various combinations of such features and capabilities (e.g., local or remote object spawning, haptic wearable feedback (e.g., from a glove, bodysuit, etc.), databases of haptic interaction properties, and so forth) enables enhanced enhancement of XR interactions and, thus, enhancement of XR interactions based on XR systems calibrated in this manner.

Various examples presented herein for supporting enhancement of XR interactions may support XR interactions within the context of telerobotics. In telerobotics, calibrating people rather than the devices—as a form of job training or introduction to a new tool—is typically done to gain the understanding of how cutting/manipulating different textures feels via a remote system (i.e., skin, bone, organs, growths, objects, etc.). Current systems to replicate interactions (e.g. transmit the “feel” from the local tool to the remote tool) often lose the nuances of physics for objects in different environments. Further, the replication mechanism (usually a joystick or generic hand-based controller) fails to accommodate the variety of variables, and how those “feel” are interacted with by individuals/systems. This system is also needed in XR interactions where integration is lacking between virtual and actual environments and objects. A solution is required to provide live fluid environments to augment tactical experiences in XR that require manipulations of both the touched/experienced object (e.g., the heart, sword, ball, etc.) and the tactile response to the user themselves (e.g., the glove, body suit, environment, etc.).

Various examples presented herein for supporting enhancement of XR interactions may support enhancement of XR interactions based on a system that is configured to support bidirectional, scalable haptics based on interactions between haptic gloves and objects. For example, a combination of printed objects and haptic gloves may be used for enhanced virtual haptics and sensory overlays (e.g., visual, audio, texture, smell, and so forth). For example, the physical object that is printed can have some actuations that approximate some touch. For example, the haptic glove may be configured to complement missing conditions (e.g., acuity, fine-grained manipulations, and the like). For example, the system may understand typical interactions, interactions that have anomalies and so forth, thereby enabling enhancements for users in tactile systems. For example, a user can train/calibrate on a virtual object across different conditions so as to support training which is specific to the specific virtual haptic interface being used (e.g., training on the conditions that the tool represents instead of the tool itself), thereby providing enhancements over traditional training which generally is not specific to the specific virtual haptic interface being used. For example, real-time updates from sensors in real objects and transmission and actuation on virtual haptics may be used for supporting enhancement of XR interactions.

It will be appreciated that various examples presented herein for supporting enhancement of XR interactions may be further understood by considering certain use case examples as discussed further below.

In one example, support for enhancement of XR interactions may be used in an immersive task use case. During intake, an object may be analyzed and object properties of the object (e.g., sight, sound, smell, dimensionality, structural variances, and so forth) may be recorded. Various asset streams may be analyzed to create a virtual model of the object. The modeling may use various feature inputs (e.g., color, text, shape, and so forth) across different individuals. Any anomalies and/or personalizations for the specific end user (e.g., a patient in a medical context or any other suitable end users) may be determined. The virtual object may then be physically recreated (e.g., 3D printed) as a physical object on the remote side. The physical object that is created may have one or more IoT components embedded therein or otherwise associated therewith for obtaining various types of feedback which may be measured by IoT components (e.g., torque, pressure, temperature, and so forth). The real haptic gloves on the remote side may be programmed with the proper haptic response for the object (e.g., for the virtual object that is representative of the corresponding physical object that is created), such as with the proper temperature, tactile response, and so forth. There may be additional simulations where the haptic glove and the object interact (e.g., a rough object with a spiky/electric glove, a smooth object with a smooth glove, and so forth).

In one example, support for enhancement of XR interactions may be used in a user training use case. A process may be repeated by a user for a particular object, using multiple instances of the object having variations in characteristics of the object, so that the user is trained for the object and variances of the object that may arise, thereby preparing the user for the object and variances of the object that may arise. The different instances of the object may be determined by the system and printed by the 3D printer so that the user may use the haptic glove to interact with the different instances of the object. This may be used in various training scenarios, such as for training a medical professional to handle organs that may have variations from patient to patient (e.g., hearts which may have different sizes, shapes, and so forth). For example, in a medical setting, the body of a patient may be analyzed and recorded for sight, sound, smell, dimensionality, internal organ structure, and so forth. The system may determine an anomaly of an organ based on the scan. The target organ is printed multiple times, with actuators and IoT for collecting information about interaction between the haptic glove and the different instances of the organ, with variations in characteristics of the target organ (e.g., a first organ may be printed without any variation, a second organ may be printed with a different shape, a third organ may be printed with a smaller size, a fourth organ may be printed with a smaller size and different shape, a fifth organ may be printed with a larger size, a sixth organ may be printed with a larger size and different shape, and so forth). The user uses the haptic glove to interact with the various instances of the target organ, thereby training the user for the object and variances of the object that may arise. It will be appreciated that this type of training based on interaction between haptic gloves and multiple instances of an object may be used within various other training scenarios (e.g., gaming applications, military applications, space program applications, and so forth).

In one example, support for enhancement of XR interactions may be used in a complex texture analysis use case. The complex texture may be analyzed for providing improved tactile response for haptic gloves. The complex texture analysis may be performed by both the object and the haptic gloves based on handling of the object by the user using the haptic gloves. An object may be printed such that it has embedded actuators or can be printed to accommodate insertion of these actuators. The actuators may be configured to collect tension and torque responses as the user handles the object with the haptic gloves. Similarly, the haptic gloves may be configured to collect interactive detail (e.g., macro detail, micro detail, and so forth). The haptic gloves may be configured to collect such interactive detail based on a scalable sensor array which is part of the haptic gloves. The scalable sensor array may be configured to collect such interactive detail based on a scalable sensor array that is configured to provide support for analysis of texture along the fingers of the haptic gloves. The tension and torque responses from the object and/or the interactive detail from the haptic gloves may be analyzed to provide improved tactile response for haptic gloves. It will be appreciated that the tension and torque responses from the object and/or the interactive detail from the haptic gloves also may be analyzed to provide object property information which may be stored for that object type and which may be accessed by users interacting with objects of the object type for supporting improved interaction between objects of that object type and haptic gloves.

It will be appreciated that the foregoing use case examples represent merely a few of the numerous use cases to which support for enhancement of XR interactions may be applied.

It will be appreciated that support for enhancement of XR interactions may be used in various use cases, may be used within various contexts, may be used for various purposes, and so forth. In one example, support for enhancement of XR interactions may be used to support enhanced scanning and approximation of internal organs with embedded sensors wrapped around the organs, thereby supporting non-invasive scanning and understanding before actual surgeries are performed. In one example, support for enhancement of XR interactions may be used in combination with implantation of enhanced sensors around organs in order to understand other components. In one example, support for enhancement of XR interactions may be used to support a ranking or scoring system configured for scoring interactions (e.g., multiple interactions by the same person, multiple interactions by different people, and so forth) to correlate typical actions in a particular interaction (e.g., actions in a particular type of surgery). In one example, support for enhancement of XR interactions may be used to support a ranking or scoring system configured for scoring interactions (e.g., multiple interactions by the same person, multiple interactions by different people, and so forth) which may be used in a “gig” economy context where multiple individual doctors can perform respective portions of a surgery (e.g., where selection of the doctors for the respective portions of the surgery may be based on various factors such as demand, skill, time, and so forth). In one example, support for enhancement of XR interactions may be used to support use of automated interactions (e.g., robotics, AI, and so forth) rather than human interactions for various purposes where interaction training may be performed through various learning systems (e.g., Generative Adversarial Networks (GANs), reinforcement learning such as deep reinforcement learning (DRL), and so forth) before actual interactions are performed (e.g., enabling automated interaction entities to learn on disposable 3D objects before performing actual interactions on actual objects in real scenarios). In one example, support for enhancement of XR interactions may be used within the context of nanobots deployed for remote simulation, deployed for the addition of other feelings of moving texture and flows in process (e.g., a sensation of movement of fluids, such as where the XR experience involves providing a sensation of moving water a sensation of blood flow in a surgery, and the like), and so forth. In one example, support for enhancement of XR interactions may be used to move nanobots or other IoT sensoring via external magnetic control. In one example, support for enhancement of XR interactions may be used for determining and controlling simulation of complicated layers of textures (e.g., in a brain surgery, layers such as the skull, then the brain, then veins of the brain, and so forth), with visual overlay on top of virtual haptics. In one example, support for enhancement of XR interactions may be used for supporting local or remote just-in-time placement of physical objects (e.g., 3D printed objects) or virtual objects which may be placed within various contexts (e.g., placement of a scalpel in surgery, placement of a virtual control for controlling an object, and so forth). In one example, support for enhancement of XR interactions may be used to support various types of haptic representations (e.g., haptic gloves, haptic body suit, and so forth) of resistance (e.g., electronic manipulation, puppet strings, and so forth). It will be appreciated that support for enhancement of XR interactions may be used in various other use cases, may be used within various other contexts, may be used for various other purposes, and so forth.

FIG. 3 illustrates a flowchart of an example method for supporting enhancement of XR interactions based on replication of XR interactions. In one example, the method 300 may be performed by one or more components of the system 100 of FIG. 1 (e.g., the XR system 102, the XR server 130, or other suitable devices). In one example, the method 300 may be performed by one or more components presented within the context of method 200 of FIG. 2 (e.g., the XR system 202, the XR server 230, or other suitable devices). In one example, various steps, functions, or operations of method 300 may be performed by one or more computing systems similar to computing system 500 as described in connection with FIG. 5 below. For instance, the computing system 500 may represent any one or more components of the system 100 of FIG. 1 that is/are configured to perform steps, functions, and/or operations of the method 300. Similarly, in one example, steps, functions, and/or operations of method 300 may be performed by a processing system including one or more computing devices collectively configured to perform various steps, functions, and/or operations of the method 300. For instance, multiple instances of the computing system 500 may collectively function as a processing system. As illustrated in FIG. 3, the method 300 begins in step 305 and proceeds to step 310.

At step 310, the processing system may obtain a set of extended reality experience information associated with an extended reality experience, wherein the set of extended reality experience information is indicative of an expected extended reality experience for an object type.

At step 320, the processing system may obtain a set of object property information of a first object of the object type in the extended reality experience. In one example, the set of object property information is obtained based on at least one of a message from a user device associated with the haptic wearable device, a message from the haptic wearable device, and a message from the first object.

At step 330, the processing system may obtain a set of haptic device capability information of a wearable haptic device used to interact with the first object in the extended reality experience. In one example, the set of haptic device capability information is obtained based on at least one of a message from a user device associated with the haptic wearable device and a message from the haptic wearable device.

At step 340, the processing system may determine, based on the set of object property information and the set of haptic device capability information, an actual extended reality experience for the object type. In one example, the actual extended reality experience for the object type is indicative of a set of actual object interaction properties experienced during the extended reality experience. In one example, the set of actual object interaction properties experienced during the extended reality experience may be based on an interaction that is experienced based on a combination of a set of object properties of the object and a set of haptic device capabilities of the haptic wearable device.

At step 350, the processing system may determine a delta between the expected extended reality experience for the object type and the actual extended reality experience for the object type. In one example, the processing system may determine the delta between the expected extended reality experience for the object type and the actual extended reality experience for the object type by the processing system by determining, based on the set of extended reality experience information associated with an extended reality experience, a set of object type property information for the object type, determining, based on the actual extended reality experience, a set of actual object interaction properties experienced during the extended reality experience, and determining, based on the set of object type property information for the object type and the set of actual object interaction properties experienced during the extended reality experience, the delta between the expected extended reality experience for the object type and the actual extended reality experience for the object type.

At step 360, the processing system may initiate, based on the delta between the expected extended reality experience for the object type and the actual extended reality experience for the object type, a message configured to cause a printing of a second object of the object type for the extended reality experience. In one example, wherein the message is intended for a 3D printer configured to print the second object. In one example, the extended reality experience is associated with a first geographic location, wherein the processing system is associated with a second geographic location, wherein the second object is printed at the first geographic location. In one example, the first object comprises a virtual object and the second object comprises a physical object. In one example, the first object comprises a first physical object and the second object comprises a second physical object. In one example, the second object has a set of properties based on the delta between the expected extended reality experience for the object type and the actual extended reality experience for the object type. In one example, the processing system may initiate, based on the initiating of the message configured to cause the printing of the second object of the object type for the extended reality experience, a message configured to notify a user of an availability of the second object. Following step 360, the method 300 proceeds to step 395 where the method 300 ends.

It will be appreciated that the method 300 may be expanded to include additional steps, or may be modified to replace steps with different steps, to combine steps, to omit steps, to perform steps in a different order, and so forth. It will be appreciated that these and other modifications are all contemplated within the scope of the present disclosure. In one example, method 300 may include one or more steps of method 200 of FIG. 2, one or more steps of method 400 of FIG. 4, and the like. In one example, the processing system may obtain, from the haptic wearable device, a set of haptic feedback information collected by the haptic wearable device based on an interaction between the haptic wearable device and the second object and update, based on the set of haptic feedback information, at least a portion of the set of extended reality experience information. In one example, the processing system may obtain, from the second object, a set of object feedback information collected by the second object based on an interaction between the haptic wearable device and the second object and update, based on the set of object feedback information, at least a portion of the set of extended reality experience information. In one example, the processing system may obtain, from the haptic wearable device, a set of haptic feedback information collected by the haptic wearable device based on an interaction between the haptic wearable device and the second object, obtain, from the second object, a set of object feedback information collected by the second object based on an interaction between the haptic wearable device and the second object, and initiate, based on at least one of the set of haptic feedback information and the set of object feedback information, a message configured to cause a printing of a third object of the object type for the extended reality experience.

It will be appreciated, although not expressly specified above, one or more steps of the method 300 may include a storing, displaying, and/or outputting steps as required for a particular application. In other words, any data, records, fields, and/or intermediate results discussed in the method can be stored, displayed, and/or outputted to another device as required for a particular application. Furthermore, operations, steps, or blocks in FIG. 3 that recite a determining operation or involve a decision do not necessarily require that both branches of the determining operation be practiced. In other words, one of the branches of the determining operation can be deemed as an optional step. Thus, the use of the term “optional step” is intended to reflect different variations of a particular illustrative example and is not intended to indicate that steps not labelled as optional steps to be deemed to be essential steps. Furthermore, operations, steps, or blocks of the above described method(s) can be combined, separated, and/or performed in a different order from that described above, without departing from the examples of the present disclosure.

FIG. 4 illustrates a flowchart of an example method for supporting enhancement of XR interactions based on calibration of XR interactions. In one example, the method 400 may be performed by one or more components of the system 100 of FIG. 1 (e.g., the XR system 102, the XR server 130, or other suitable devices). In one example, the method 400 may be performed by one or more components presented within the context of method 200 of FIG. 2 (e.g., the XR system 202, the XR server 230, or other suitable devices). In one example, the steps, functions, or operations of method 400 may be performed by a computing system 500 as described in connection with FIG. 5 below. For instance, the computing system 500 may represent any one or more components of the system 100 of FIG. 1 that is/are configured to perform the steps, functions, and/or operations of the method 400. Similarly, in one example, the steps, functions, and/or operations of method 400 may be performed by a processing system including one or more computing devices collectively configured to perform various steps, functions, and/or operations of the method 400. For instance, multiple instances of the computing system 500 may collectively function as a processing system. As illustrated in FIG. 4, the method 400 begins in step 405 and proceeds to step 410.

At step 410, the processing system may send, toward a device, a set of extended reality experience information associated with an extended reality experience, wherein the extended reality experience is based on an interaction between a haptic wearable device and an object.

At step 420, the processing system may obtain, from the haptic wearable device, a set of haptic feedback information collected by the haptic wearable device based on the interaction between the haptic wearable device and the object.

At step 430, the processing system may obtain, from the object, a set of object feedback information collected by the object based on the interaction between the haptic wearable device and the object.

At step 440, the processing system may update, based on at least one of the set of haptic feedback information and the set of object feedback information, at least a portion of the set of extended reality experience information associated with the extended reality experience to form thereby a new set of extended reality experience information associated with the extended reality experience.

At step 450, the processing system may send, toward the device, the new set of extended reality experience information associated with the extended reality experience. Following step 450, the method 400 proceeds to step 495 where the method 400 ends.

It will be appreciated that the method 400 may be expanded to include additional steps, or may be modified to replace steps with different steps, to combine steps, to omit steps, to perform steps in a different order, and so forth. It will be appreciated that these and other modifications are all contemplated within the scope of the present disclosure. In one example, method 400 may include one or more steps of method 200 of FIG. 2, one or more steps of method 300 of FIG. 3, and the like.

It will be appreciated, although not expressly specified above, one or more steps of the method 400 may include storing, displaying, and/or outputting steps as required for a particular application. In other words, any data, records, fields, and/or intermediate results discussed in the method can be stored, displayed, and/or outputted to another device as required for a particular application. Furthermore, operations, steps, or blocks in FIG. 4 that recite a determining operation or involve a decision do not necessarily require that both branches of the determining operation be practiced. In other words, one of the branches of the determining operation can be deemed as an optional step. Thus, the use of the term “optional step” is intended to reflect different variations of a particular illustrative example and is not intended to indicate that steps not labelled as optional steps to be deemed to be essential steps. Furthermore, operations, steps, or blocks of the above described method(s) can be combined, separated, and/or performed in a different order from that described above, without departing from the examples of the present disclosure.

It will be appreciated that various examples of the present disclosure for supporting enhancement of XR interactions may provide various advantages or potential advantages. For example, various examples of the present disclosure for supporting enhancement of XR interactions may support enhanced VR experiences combining reality with virtual reality. For example, various examples of the present disclosure for supporting enhancement of XR interactions may support use of AI for correlation of previous object interactions to new tactile experiences by combining IoT objects and haptic gloves. For example, various examples of the present disclosure for supporting enhancement of XR interactions may support updating of one or more haptics information databases trained by multiple users and accessed by multiple users to provide more consistent XR experiences across users. For example, various examples of the present disclosure for supporting enhancement of XR interactions may support updating of one or more object information databases trained by multiple users and accessed by multiple users to provide more consistent XR experiences across users. For example, various examples of the present disclosure for supporting enhancement of XR interactions may support uniform experiences in different locations so that different users (e.g., at different times, in different locations, and so forth) can have the same or similar XR interactions (e.g., have the same XR gaming experiences, be trained for the same activity consistently, and so forth). It will be appreciated that various examples of the present disclosure for supporting enhancement of XR interactions may provide various other advantages or potential advantages.

It will be appreciated that, as used herein, the terms “configure” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures, and the like, which may cause a processing system executing computer-readable instructions, code, and/or programs to function differently depending upon the values of the variables or other data structures that are provided. As referred to herein, a “processing system” may include a computing device including one or more processors or cores or multiple computing devices collectively configured to perform various steps, functions, and/or operations as discussed herein.

FIG. 5 depicts a high-level block diagram of a computing system 500 (e.g., a computing device or processing system) specifically programmed to perform the functions described herein. For example, any one or more components or devices illustrated in FIG. 1, or described in connection with the method 200 of FIG. 2, the method 300 of FIG. 3, or the method 400 of FIG. 4, may be implemented as the computing system 500. As depicted in FIG. 5, the computing system 500 comprises a hardware processor element 502 (e.g., comprising one or more hardware processors, which may include one or more microprocessor(s), one or more central processing units (CPUs), and the like, where the hardware processor element 502 may also represent one example of a “processing system” as referred to herein), a memory 504 (e.g., random access memory (RAM), read only memory (ROM), a disk drive, an optical drive, a magnetic drive, a Universal Serial Bus (USB) drive, and the like), a module 505 for supporting enhancement of XR interactions, and various input/output devices 506 (e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It will be appreciated that, although one hardware processor element 502 is shown, the computing system 500 may employ a plurality of hardware processor elements. Furthermore, although one computing device is shown in FIG. 5, if the methods as discussed above are implemented in a distributed or parallel manner for a particular illustrative example, e.g., the steps of the above methods or the entire methods are implemented across multiple or parallel computing devices, then the computing system 500 of FIG. 5 may represent each of those multiple or parallel computing devices. Furthermore, one or more hardware processor elements 502 can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 502 can also be configured or programmed to cause other devices to perform one or more operations as discussed above. In other words, the hardware processor element 502 may serve the function of a central controller directing other devices to perform the one or more operations as discussed above.

It will be appreciated that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the module 505 for supporting enhancement of XR interactions (e.g., a software program comprising computer-executable instructions) can be loaded into memory 504 and executed by hardware processor element 502 to implement the steps, functions or operations as discussed above in connection with the example method 200 of FIG. 2, the example method 300 of FIG. 3, or the example method 400 of FIG. 4. Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The hardware processor element 502 executing the computer-readable instructions relating to the above described method(s) can be perceived as a programmed processor or a specialized processor. As such, the module 505 for supporting enhancement of XR interactions (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various embodiments have been described above, it should be understood that they have been presented by way of example and not limitation. Thus, the breadth and scope of a preferred embodiment should not be limited by any of the above-described example embodiments, but should be defined in accordance with the following claims and their equivalents.

What is claimed is:

1. A method comprising:
obtaining, by a processing system including at least one processor, a set of extended reality experience information associated with an extended reality experience, wherein the set of extended reality experience information is indicative of an expected extended reality experience for an object type;
obtaining, by the processing system, a set of object property information of a first object of the object type in the extended reality experience;
obtaining, by the processing system, a set of haptic device capability information of a wearable haptic device used to interact with the first object in the extended reality experience;
determining, by the processing system based on the set of object property information and the set of haptic device capability information, an actual extended reality experience for the object type;
determining, by the processing system, a delta between the expected extended reality experience for the object type and the actual extended reality experience for the object type; and
initiating, by the processing system based on the delta between the expected extended reality experience for the object type and the actual extended reality experience for the object type, a message configured to cause a printing of a second object of the object type for the extended reality experience.

2. The method of claim 1, wherein the set of object property information is obtained based on at least one of a message from a user device associated with the haptic wearable device, a message from the haptic wearable device, and a message from the first object.

3. The method of claim 1, wherein the set of haptic device capability information is obtained based on at least one of a message from a user device associated with the haptic wearable device and a message from the haptic wearable device.

4. The method of claim 1, wherein the determining of the delta between the expected extended reality experience for the object type and the actual extended reality experience for the object type comprises:
determining, by the processing system based on the set of extended reality experience information associated with the extended reality experience, a set of object type property information for the object type;
determining, by the processing system based on the actual extended reality experience, a set of actual object interaction properties experienced during the extended reality experience; and
determining, by the processing system based on the set of object type property information for the object type and the set of actual object interaction properties experienced during the extended reality experience, the delta between the expected extended reality experience for the object type and the actual extended reality experience for the object type.

5. The method of claim 1, wherein the second object has a set of properties based on the delta between the expected extended reality experience for the object type and the actual extended reality experience for the object type.

6. The method of claim 1, wherein the message is intended for a three-dimensional printer configured to print the second object.

7. The method of claim 1, wherein the extended reality experience is associated with a first geographic location, wherein the processing system is associated with a second geographic location, wherein the second object is printed at the first geographic location.

8. The method of claim 1, further comprising:
initiating, by the processing system based on the initiating of the message configured to cause the printing of the second object of the object type for the extended reality experience, a message configured to notify a user of an availability of the second object.

9. The method of claim 1, wherein the first object comprises a virtual object and the second object comprises a physical object.

10. The method of claim 1, wherein the first object comprises a first physical object and the second object comprises a second physical object.

11. The method of claim 1, further comprising:
obtaining, by the processing system from the haptic wearable device, a set of haptic feedback information collected by the haptic wearable device based on an interaction between the haptic wearable device and the second object; and
updating, by the processing system based on the set of haptic feedback information, at least a portion of the set of extended reality experience information.

12. The method of claim 1, further comprising:
obtaining, by the processing system from the second object, a set of object feedback information collected by the second object based on an interaction between the haptic wearable device and the second object; and
updating, by the processing system based on the set of object feedback information, at least a portion of the set of extended reality experience information.

13. The method of claim 1, further comprising:
obtaining, by the processing system from the haptic wearable device, a set of haptic feedback information collected by the haptic wearable device based on an interaction between the haptic wearable device and the second object;
obtaining, by the processing system from the second object, a set of object feedback information collected by the second object based on an interaction between the haptic wearable device and the second object; and
initiating, by the processing system based on at least one of the set of haptic feedback information and the set of object feedback information, a message configured to cause a printing of a third object of the object type for the extended reality experience.

14. The method of claim 13, wherein the second object and the third object differ in at least one object property.

15. An apparatus comprising:
a processing system including at least one processor; and
a computer-readable medium storing instructions which, when executed by the processing system, cause the processing system to perform operations, the operations comprising:
obtaining a set of extended reality experience information associated with an extended reality experience, wherein the set of extended reality experience information is indicative of an expected extended reality experience for an object type;
obtaining a set of object property information of a first object of the object type in the extended reality experience;
obtaining a set of haptic device capability information of a wearable haptic device used to interact with the first object in the extended reality experience;
determining, based on the set of object property information and the set of haptic device capability information, an actual extended reality experience for the object type;
determining a delta between the expected extended reality experience for the object type and the actual extended reality experience for the object type; and
initiating, based on the delta between the expected extended reality experience for the object type and the actual extended reality experience for the object type, a message configured to cause a printing of a second object of the object type for the extended reality experience.

16. A method comprising:
sending, by a processing system including at least one processor toward a device, a set of extended reality experience information associated with an extended reality experience, wherein the extended reality experience is based on an interaction between a haptic wearable device and an object;
obtaining, by the processing system from the haptic wearable device, a set of haptic feedback information collected by the haptic wearable device based on the interaction between the haptic wearable device and the object;
obtaining, by the processing system from the object, a set of object feedback information collected by the object based on the interaction between the haptic wearable device and the object;
updating, by the processing system based on at least one of the set of haptic feedback information and the set of object feedback information, at least a portion of the set of extended reality experience information associated with the extended reality experience to form thereby a new set of extended reality experience information associated with the extended reality experience; and
sending, by the processing system toward the device, the new set of extended reality experience information associated with the extended reality experience.

17. The method of claim 16, wherein the set of extended reality experience information comprises a story configured to control the extended reality experience, wherein the new set of extended reality experience information comprises a modified version of the story configured to control the extended reality experience.

18. The method of claim 16, wherein the set of extended reality experience information comprises a set of haptic capability information associated with the haptic wearable device, wherein the updating of the set of extended reality experience information associated with the extended reality experience includes updating the set of haptic capability information associated with the haptic wearable device based on the set of haptic feedback information collected by the haptic wearable device.

19. The method of claim 16, wherein the set of extended reality experience information comprises a set of object property information associated with an object type of the object, wherein the updating of the set of extended reality experience information associated with the extended reality experience includes updating the set of object property information associated with the object type of the object based on the set of object feedback information collected by the object.

20. The method of claim 16, further comprising:
initiating, by the processing system based on at least one of the set of haptic feedback information and the set of object feedback information, a message for causing printing of a second object.
